(19) United States
(12) Patent Application Publication
(10) Pub. No.: US 2004/0176081 A1
(43) Pub. Date: Sep. 9, 2004

(54) Intelligent wireless messaging system

(75) Inventors: Maurice John Bryham, Milford (NZ); Mark Campitt Loveys, Howick (NZ)

Correspondence Address: MERCHANT & GOULD PC, P.O. BOX 2903, MINNEAPOLIS, MN, 55402-0903, US

(73) Assignee: DATASQUIRT LIMITED, AUCKLAND (NZ)

(21) Appl. No.: 10/738,787

(22) Filed: Dec. 15, 2003

Related U.S. Application Data
(63) Continuation-in-part of application No. PCT/NZ02/00111, filed on Jun. 14, 2002.

(30) Foreign Application Priority Data
Jun. 15, 2001 (NZ) NZ 512427
Feb. 8, 2002 (NZ) NZ 517095

(51) Int. Cl. H04M 1/66

(52) U.S. Cl. 455/414.1; 455/412.1

(57) ABSTRACT

The present invention is an interactive messaging system combining the use of short text messages via cellular telephones with a database and messaging system. Customers are able to type in a message requesting a delivery of a product or service. Additionally a system combining text messages and a database is described allowing users to store lottery numbers and be notified if they have won prizes in the lottery. A system for selecting an appropriate messaging gateway for sending messages to the user is also described.

### FIELD OF INVENTION

The present invention relates to a system for data communications particularly though not solely for data communications using wireless communication protocols.

### BACKGROUND ART

In the delivery of cellular telephones it has recently become popular to provide as well as voice communications, the ability to communicate short text messages between users on the same network. In particular the currently favored GSM digital protocol allows that any phone in the world connected to a GSM digital network in their particular country is able to send an “SMS” protocol text message directly to a phone in any other country so long as it also is connected to a GSM digital network.

Systems have been developed that allow communication between e-mail gateways and the SMS message system. The processing engine of said system translates the e-mail message into the format required by the secondary character protocol (SMS, facsimile, courier, mail etc).

Newer cellular phones allow connection directly to the Internet and allow access to E-mail. However even with these newer phones use of E-mail is labourious and sometimes slow. There are some cellular networks that determine the location of each cellular phone eg: “Location Based Services”.

There are also systems that provide information based on desired criteria to the handset. Often this will include a range of information some of which may not be relevant of desired by the specific user.

Outlook and other organization or scheduling packages have the ability to send electronic meeting requests to the desired attendees. Similarly newer cellular phones include a digital diary, from which meeting requests (Vcalender format) can be sent to other cellular phones. However since the emailed meeting requests are in a proprietary format the two systems are incompatible

### SUMMARY OF THE INVENTION

It is therefore an object of the present invention to provide a data communication system which goes some way to overcoming the disadvantages in the above mentioned prior art or which will at least provide the public with a useful choice.

In a first aspect the present invention may be broadly said to consist in a method for handling an order, said order received from any “text messaging” or other wireless data transmission protocol capable wireless communication device, comprising the steps of:

receiving an order message from said wireless device;

extracting an indication of the identity of said wireless device from said order message;

obtaining information associated with said indicated identity, said information comprising information on a wireless device user associated with said wireless device identity and a nominated method of payment for said order; and

sending an order confirmation message using said identity to said wireless device.

Preferably said method for handling an order further comprising the step of verifying the ability to fulfill said order.

Preferably said method for handling an order further comprising the step of receiving information on a wireless device user, said information comprising said indicated identity of a wireless device associated with said wireless device user.

Preferably said method for handling an order further comprising the step of receiving and storing information on a wireless device user prior to receiving orders, said information comprising said indicated identity of a wireless device associated with said wireless device user.

Preferably the step of receiving information on a wireless device user comprises the steps of:

providing an information collecting interface for said wireless device user to provide said information; and

receiving said information provided by said wireless device user from said information collecting interface.

Preferably said information on said wireless device user further comprises at least one delivery address.

Preferably said information on said wireless device user further comprises at least one method of payment.

Preferably said method for handling an order further comprising the step of receiving a confirmation message from said wireless device indicating at least confirmation of said order.

Preferably said method for handling an order further comprising the step of storing a plurality of codes, each said code being associated with one or more items and wherein said order message comprises at least one said code and said order comprises the said one or more items associated with each said received code in said order message.

Preferably the said one or more items associated with a said received code in said order message depend on said indicated identity and said method further comprising the step of receiving information on items to be associated with a said received code for a said indicated identity.

Preferably the step of verifying the ability to fulfill said order comprises checking if said received code is one of said stored codes.

Preferably said order message further comprises an indication of the quantity of each said code.

Preferably said order message further comprises a delivery address code and said method further comprising the steps of:

receiving information on a delivery address to be associated with a said delivery address code and a said indicated identity; and

retrieving the delivery address associated with said delivery address code for said order.

Preferably said delivery address to be associated with a said delivery address code and a said indicated identity is received from an information collecting interface.

Preferably wherein said request message comprises a delivery address.

Preferably said confirmation message comprises a delivery address.

Preferably said method for handling an order further comprising the step of communicating said order and said confirmation to a third party for billing purposes.

Preferably said method for handling an order further comprising the step of communicating an order for at least one ordered item to an appropriate supplier.

Preferably the step of communicating an order for at least one ordered item to an appropriate supplier comprises communicating a delivery address.

Preferably the step of communicating an order for at least one ordered item to an appropriate supplier further comprises communicating a method of payment.

Preferably the step of verifying the ability to fulfill said order comprises the steps of:

communicating a request for fulfillment capability information on each ordered item to at least one appropriate supplier; and

receiving fulfillment capability information from suppliers.

Preferably said information collecting interface is a web form.

In a second aspect the present invention may be broadly said to consist in a system for handling an order, said order received from any “text messaging” or other wireless data transmission protocol capable wireless communication device, comprising:

means for receiving an order message from said wireless device;

means for extracting an indication of the identity of said wireless device from said order message;

means for obtaining information associated with said indicated identity, said information comprising information on a wireless device user associated with said wireless device identity and a nominated system of payment for said order; and

means for sending an order confirmation message using said identity to said wireless device.

Preferably said system for handling an order further comprising means for verifying the ability to fulfill said order.

Preferably said system for handling an order further comprising means for receiving information on a wireless device user, said information further comprising said indicated identity of a wireless device associated with said wireless device user.

Preferably said system for handling an order further comprising means for receiving and storing information on a wireless device user prior to receiving orders, said information further comprising said indicated identity of a wireless device associated with said wireless device user.

Preferably the means for receiving information on a wireless device user comprises:

an information collecting interface for said wireless device user to provide said information; and

means for receiving said information provided by said wireless device user from said information collecting interface

Preferably said information on said wireless device user further comprises at least one delivery address.

Preferably said information on said wireless device user further comprises at least one method of payment.

Preferably said system for handling an order further comprising means for receiving a confirmation message from said wireless device indicating at least confirmation of said order.

Preferably said system for handling an order further comprising means for storing a plurality of codes, each said code being associated with one or more items and wherein said order message comprises at least one said code and said order comprises the said one or more items associated with each said received code in said order message.

Preferably the means for verifying the ability to fulfill said order comprises checking if said received code is one of said stored codes.

Preferably the said one or more items associated with a said received code in said order message depend on said indicated identity and said system further comprising means for receiving information on items to be associated with a said received code for a said indicated identity.

Preferably said order message further comprises an indication of the quantity of each said code.

Preferably said order message further comprises a delivery address code and said system further comprises:

means for receiving information on a delivery address to be associated with a said delivery address code and a said indicated identity; and

means for retrieving the delivery address associated with said delivery address code for said order.

Preferably said delivery address to be associated with a said delivery address code and a said indicated identity is received from an information collecting interface.

Preferably said request message comprises a delivery address.

Preferably said confirmation message comprises a delivery address.

Preferably said system for handling an order further comprising means for communicating said order and said confirmation to a third party for billing purposes.

Preferably said system for handling an order further comprising means for communicating an order for at least one ordered item to an appropriate supplier.

Preferably communicating an order for at least one ordered item to an appropriate supplier comprises communicating a delivery address.

Preferably communicating an order for at least one ordered item to an appropriate supplier further comprises communicating a method of payment.

Preferably verifying the ability to fulfill said order comprises:

means for communicating a request for fulfillment capability information on each ordered item to at least one appropriate supplier; and

means for receiving fulfillment capability information from suppliers.

Preferably said information collecting interface is a web form.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

Preferred forms of the present invention will now be described with reference to the accompanying drawings in which:

FIG. 1 is a block diagram of the architecture according to the preferred embodiment of the present invention and

FIG. 2 is a block diagram of a SMS purchase system according to the present invention.

FIG. 3 is a schematic diagram of the SMS purchase system according to the present invention.

FIG. 4 is a schematic diagram of the messaging engine system according to the present invention.

FIG. 5 is a flow diagram of the order process according to the present invention.

### DETAILED DESCRIPTION OF THE PREFERRED EMBODIMENTS

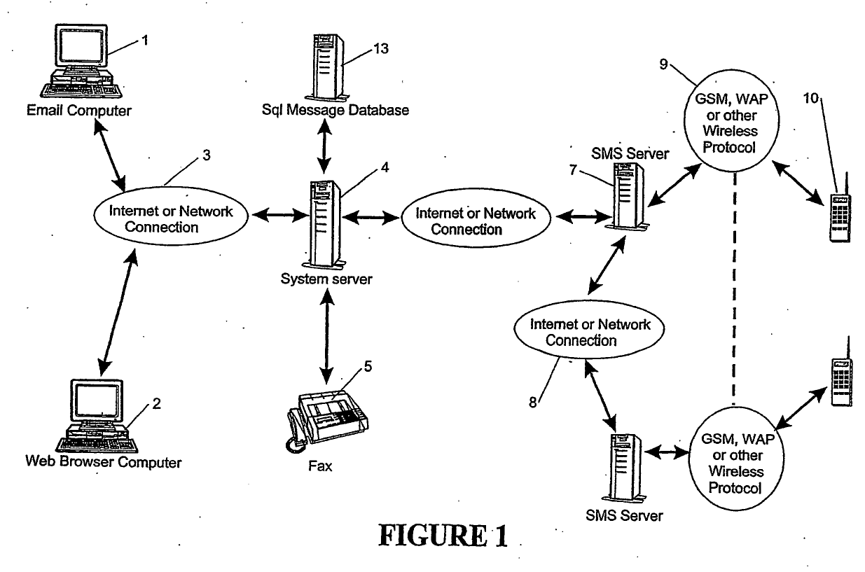

Referring to FIG. 1 the present invention is depicted with a number of users connected through various interfaces. In the preferred embodiment a system server 4 is connected by a data network, either the Internet 3 or other data communications to a plurality of local user interfaces 1,2. Each local user interfaces 1,2 will typically include E-mail software preferably with organizational or scheduling capacity eg: Microsoft Outlook. As is known in the art E-mail messages including attachments may be sent from one local user interface 1 to another local user interface 2 or in the preferred embodiment to the system server 4. Typically each of the local user interfaces 1, 2 will have a single E-mail address, whereas the system server 4 may have provision for a large number of E-mail addresses.

In the preferred embodiment of the present invention each of the local user interfaces 1, 2 are able to send an E-mail including a telephone number (of a cellular telephone connected to one of a certain number of approved cellular networks) as part of the address to the system server 4. The system server 4 includes a database 13 to store each received message for later actions and billing purposes. A relational database such as SQL or others as are known in the art would be suitable for this purpose.

The system server 4 is in turn connected to SMS gateway 7. The SMS gateway is capable of sending and receiving seven or eight bit data packets which often include short text messages or other data such as Calendar or Vcard messages. Each SMS gateway 7 is connected through a cellular network 9 eg: GSM or other protocols to each cellular telephone 10. Each SMS gateway 7 is connected to other SMS gateways eg: in other countries, thorough the Internet or other data communications network 8. In turn each cellular network 9 is interconnected to other cellular networks through similar data communications networks.

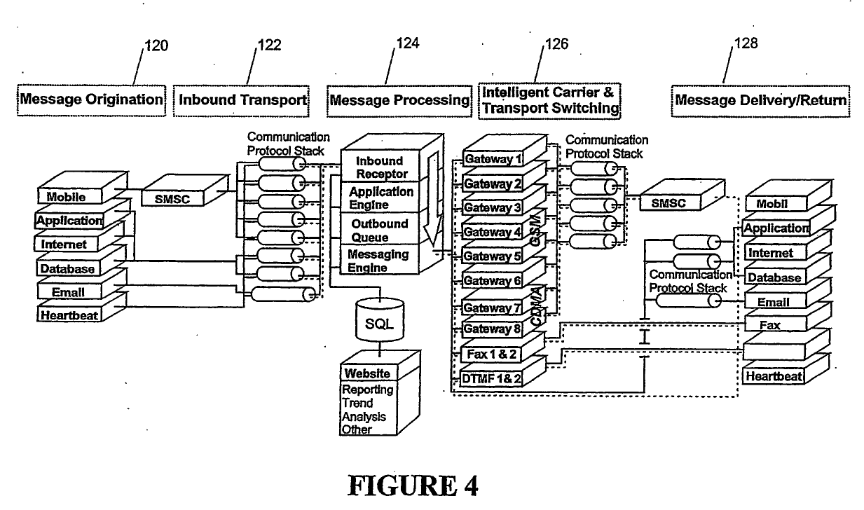

Referring now to FIG. 4 the present invention according to one preferred embodiment is illustrated with each step in the process implemented by the messaging engine or system server or text code server broken up to its requisite functional components. For example message origination 120 includes the sources such as mobile originate ie SMS, application software, internet or database originate, email originate or heart beat (internal) which then is supplied to the inbound transport operation 122. The communication protocol stack processes the message processing 124 into functions such as the inbound receptor, the application engine, the outbound queue, the messaging engine as well as interfacing with a SQL database and website reporting trend analysis and other etc. From there intelligent carrier and transport switching 126 interfaces with a number of GSM, CDMA and facsimile gateways which send messages to the external world. For example message delivery return 128 can be received by an SMS mobile application internet or database software, email, facsimile or internally routed messaging.

Message Response System

In the preferred embodiment a user sends an initiating E-mail to the system server 4. The E-mail will have an address eg: 6421631071@mysystem.com which includes the domain name of the system server 4 eg: mysystem.com and the full telephone number eg: 6421631071 of a cellular telephone 10. The E-mail itself may include a simple message to be conveyed to the cellular telephone or may be formatted as a response required question. Generally the question will only require a simple one key answer from the cellular telephone user.

The system server 4 receives the E-mail and converts the content from E-mail format into SMS format. The initiating text message is then sent to the SMS gateway 7 addressed to the full telephone number of the cellular telephone 10. After sending, the system server 4 stores message key in association with the message in the database 13. The message key is received from the SMS gateway 7 as identification of the message.

If the cellular telephone 10 replies to the system server 4 associates the response message back to the initiating message using the stored message key from the database. In one embodiment of the present invention on receipt of the response message the system server 4 sends a response E-mail back to the original sender, including the initiating message and the response message. For example if in the initiating E-mail included the question “Do you want to go to dinner tonight?” and the response message was “Y”, the response E-mail might be:

You asked Ryan

“Do you want to go to dinner tonight?”

Ryan replied

“Yes”

Or alternatively if the question was “What time do you want to go to dinner tonight?”:

You asked Ryan

“What time do you want to go to dinner tonight?”

Ryan replied

“9 pm”

In a further embodiment the receipt of the response message above “17” ie: 9 pm might then result in a booking request being emailed to a restaurant. This might for example be in the form of a meeting request if the restaurant in question was using Microsoft Outlook or other scheduling software.

In an still further embodiment of the present invention the initiating E-mail could include the full facsimile number of a desired recipient by facsimile transmission. On receipt of the initiating E-mail the system server 4 would send an initiating facsimile to facsimile machine 5.

Targeted Message Alerts

In another preferred embodiment of the present system the system server 4 would poll the SMS gateways 7 for the current location of the cellular telephone 10 of a registered user. Software on the system server tracks the location over time and using stored geographical information predicts where the user might be in for example 10 min. The system server then looks through its database of updated information to see if it can locate information relevant to that predicted future location. If something of relevance is located a message is sent.

The prediction of future location may be made using any number of intelligent algorithms as art known in the art. In the preferred embodiment the specific geographic location, the direction of travel and the speed of travel are tracked. This is matched against a set of rules to predict if the user falls within one of a number of known activities eg: traveling along the motorway, going to the gym etc. Once a prediction has been made where the registered user has requested certain information eg: traffic updates on the motorway they are traveling they will be sent information only if the conditions are met.

Similarly the user may request that alerts be only sent in certain circumstances. For example only send the swell at the beach if its over a certain level; only send me information on a specific motorway if the user is traveling on that particular motorway; only send me weather information when the outlook changes and only between certain hours. When the user registers they can chose from a range of alerts any conditions on when the alerts are sent or a combination of conditions to be met.

Also when the alerts are sent part of the content could be depicted by logos, pictures or even tunes. The picture messages or logos could be chosen by software on the system server 7 as being relevant or representative of information. For example if it was a overcast day with possibility of rain you might have a message sent with a picture of cloud with some rain coming out of it, if it was a sunny day you might have a sun. Also services of this type might be provided free if a simple advertisement were appended at the end each alert. The advertiser would benefit since by registering for that particular alert the user is likely to fall within a particular target audience which the advertiser is targeting.

Converting Meeting Requests

As already mentioned Microsoft Outlook meeting requests are incompatible with the Calendar format used in GSM digital cellular telephones. In the preferred embodiment, the present invention converts meeting requests emailed to a cellular telephone to the Calendar format.

As previously described the system server 4 receives emails addressed in part to the telephone number of the cellular telephone 10. In this case the E-mail takes the form of a meeting request format. Software on the system server 4 recognizes the format of the message and converts the content into the Calendar format. An SMS Calendar message is then sent to the cellular telephone 10 through the SMS gateway 7. Options to view, save and discard are available at time of receipt of the message.

Similarly the system server 4 will recognize a contact information type E-mail and convert it to a Vcard message. This is sent through the SMS gateway 7 and recognized by the cellular telephone 10 as a Vcard whereby those contact details are entered into the local address book. If the present invention was not used the messages would not be recognized as Calendar or Vcard messages—the cellular telephone would interpret them as simple messages.

SMS Gateway Switching

In order to get a good balance between cost and performance of the system in the preferred embodiment, the present invention is able to dynamically switch between a range of SMS gateways based on a number of preset criteria. The criteria are arbitrary but in the preferred embodiment software on the system server 4 periodically tests each route 7 for speed of delivery.

The system tests the performance of each route by sending loop back test messages. The loop back tests are conducted by generating test messages and sending the test messages using the targeted route. The system then monitors the length of time taken to receive the test message, rating the route's performance accordingly.

To decide which route 7 to use for a given message the following criteria is tested by the system:

1. Is a seven bit or eight bit route required eg: Calendar messages require eight bit, text messages only requires seven bit;

2. Has preferential service been requested—as to whether a higher quality of service ie: dependability etc and higher cost is incurred;

3. What is the current time ie: some routes will be avoided in their recognized peak times;

4. Of the remaining routes have all of them achieved a recent speed of delivery better than a threshold level of acceptable service;

5. Of the remaining routes which is the least expensive.

Once the preferred route is chosen the message is sent. If the message is not sent successfully the next most desirable route is used until the message is sent successfully.

In addition to testing the availability and performance of message routes, this system also checks the integrity of the entire system, alerting system administrators to possible problems anywhere across the system. The alert could include SMS, pager, facsimile, automated telephone or other automatic messaging facilities. The additional tests check the availability of the application, database and web servers of the system.

SMS Message Over-write

In a further embodiment the present invention may be employed to send a string of messages to a cellular telephone. This may be useful in process which requires a number of questions answered, or a large amount of information. For example a purchase order by a customer, a job tracking process, buying a Lotto ticket, placing a bet, or booking a movie ticket.

In order to prevent the message inbox of the cellular telephone becoming full and to prevent confusion regarding the current question to be answered, each subsequent message is sent with a message over-write (via the SMS carrier overwrite flag) so that the user only has one message in their inbox at any one time from the particular application.

User Purchase Confirmation

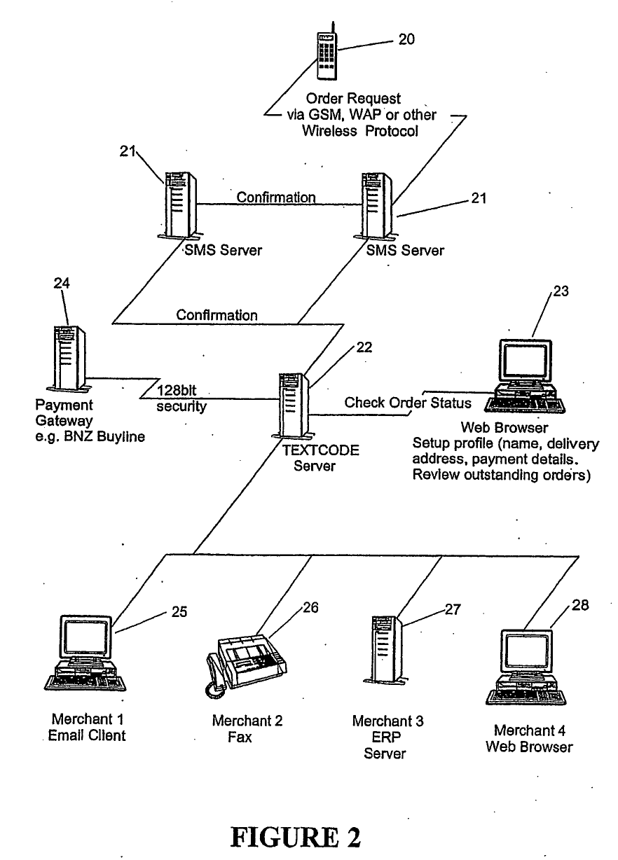

Referring to FIG. 2 in a still further embodiment of the present invention, users may request or purchase goods or services using their cellular telephone 210. A user requests a product or service by generating a MO (Mobile Originate—an SMS message that was created and sent FROM a cellular telephone) message, including for example a product code, and sending the message to the system server 22.

When the MO is received, a software application running on the system server 22 matches the product code to the product or service in a product database. The product code is unique so it not only relates to a particular product or service but also the database running on the system server 22 contains the supplier of that particular product or service. The product or service codes are added to the database by the system administrator or by administrative users of the system.

From the Caller Line Identification CLI (or other unique mobile phone caller ID) the software application matches the users cellular telephone number to the mobile users profile (Mobile) database record stored by the system. This mobile record contains the name, delivery address(s), payment detail(s), cellular telephone number and other details relating to the user. Users create the mobile user profile record using a PC 23 and an on online interface served by a system server 22 or by calling a call centre. In the case of a call centre the call centre operator creates the profile.

In an alternative embodiment the user record may be sourced for other databases by matching the cellular telephone number with a record in the other database and extracting the information for inclusion in the mobile users profile (Mobile) database record stored by the system. In a further alternative a user may register using their cellular telephone by sending in a text including information on a record from which the information for inclusion in their profile is to be sourced.

In the preferred embodiment users enter their desired payment methods and delivery destinations during the setup of their user profile on the supporting website. Once the user has entered the payment/delivery details they wish to use, they are directed to an ‘assignment’ section of the website, where they are instructed to assign preferred payment methods and delivery destinations to each available vendor. If no assignments are made by the user, defaults are selected for the user.

Caller Line Identification is included with every SMS message sent. It forms part of a compulsory SMS header which obtains the correct information directly from the SIM card of a GSM phones or from the information hard coded to the phone on TDMA/CDMA/Analogue phones.

An application on the system server 22 automatically generates a MT (Mobile Terminate—an SMS message that is sent TO a phone) message which displays the details of the product or service pricing and other details. The MT message includes a request to reply with a “Y”, “YES” or other short confirmation message to confirm the transaction. The application then generates an audit of transaction including the request and purchase confirmation and then passes the billing information onto the cellular provider's billing system for billing 27 so that the product/service can for example, appear on the users' next cellular telephone bill.

The application server then creates an order by combining the users mobile information from the system database with information on the product or service and information on the supplier. This information is then delivered to the supplier who delivers the product or service to the user. The information may be sent to the supplier by email 25, facsimile 26, data 27 or via the web browser 28. The MT message is sent back to the users mobile phone with the estimated time of delivery and/or order confirmation dialogue if required. Such confirmation message may not always be appropriate and therefore will not always be sent.

The product or service is billed to the user via the method selected in the mobile for that particular supplier. Billing options include (but are not limited to) credit card, cash on delivery, charged to an account with the supplier, charged to the mobile carriers users bill, EFTPOS, or a third party account (i.e., added onto an electricity bill).

When the user places their order via the system, the system matches their CLI against their user profile and selects the relevant payment method and delivery destination for each vendor included within the order, based on the decisions the user made at the assignments page of the website.

Sensitive information, such as credit card numbers, are stored in an encrypted state within the system database. Such information is only available to merchants when a bona fide order exists for the given vendor. Immediately following the processing of the order, said information is no longer available for the merchant.

When an order is created, notification of the order is sent to the relevant merchant(s), via email and/or SMS text message or direct communication with the merchants electronic systems. If sent by email 25 the merchant will follow a hyperlink included within the content of the email and log on to the system web server via a PC 28 to retrieve the details of the order for processing. In an alternative embodiment the system would charge the credit card and pay the merchant, requiring only product information, payment confirmation and delivery details to be sent to the merchant.

Payments made using EFTPOS, account charging, carrier account charging or third party charging will be activated by the system and payment gateway 24 using known methods based on information supplied by the user in their mobile user profile. Payment methods can include using reward points earned as a member of loyalty programs.

Customers purchasing using the system will be informed of the various merchants/product codes available for use through traditional media and such as newspapers, radio and television through the system website. Merchants will include product codes in their standard advertising, whether said advertising is destined for print, television, radio, billboards, the Internet or other. The product codes are small and unobtrusive, designed to support and complement existing merchant advertising.

The customers may also visit the supporting website using a PC 23 to learn of new merchants and product codes.

In an alterative embodiment the system would additionally allow for users to create their own product codes that may span several products or services and that, when matched with their mobile phone number through caller line identification, allow for the retrieval of the correct product/merchant information from the database.

This is useful for users who order the same products on a regular basis. For example, a user may set up a code of PARTY to represent the purchase of a selection of pizzas, and a mixture of favorite bottles of wine, all selectable by the user and assigned to their specific code and user profile using the website system. Because the transaction is ultimately matched back to the user's mobile phone number, there is no chance of errors occurring if multiple users create the same product codes.

Personal codes of this nature are set up via the supporting system website, or alternatively via a supporting telephone helpdesk.

A further enhanced feature of the system is the ability to advise an alternate preferred delivery address from within the content of the text message. Usually, the system refers back to the central database to ascertain which delivery address to use for a particular vendor. The user has the ability to override this feature by entering the product code, followed by a space, followed by a single character depicting the desired delivery address, (already existent in the database). For example, a user may enter ‘1234 W’ to place an order for product ‘1234’, to be delivered to WORK. Likewise, they may enter ‘5678 H’ to place an order for product ‘5678’, to be delivered to HOME.

In a further embodiment the user would have the ability to enter a complete address, which may be unknown to the database. This is achieved by entering the content of the order in the usual fashion, inserting a delimiting character and then entering the full desired delivery address.

The ability to order quantities of products on the fly is a key feature of the system and its capabilities. Users have the ability to order several products at once by simply separating each desired product code with a space. E.g.: ‘1234 5678 9876’, would deliver one each of the products ‘1234’, ‘5678’ and ‘9876’. Ordering quantities of the same product is achieved by adding a multiplier immediately following the product code. E.g.: ‘1234×5’ would deliver a quantity of five of product ‘1234’. A mix of these two features allows the user to order any combination of the products and quantities of those products. Furthermore, products selected may all be from separate merchants, as the system server will break the order into components and forward the relevant details to each appropriate merchant.

For the user's complete peace of mind, the confirmation message contains specific details of the order placed, the delivery destination and the total cost. Also included in the return message are any contact details for the merchant(s) so that the user may make voice contact if necessary. Confirmations for orders spanning multiple merchants are sent back in several distinct messages, indicating the individual product, cost and delivery details.

In an alternative embodiment the user will be given the opportunity in those confirmation message to alter the address.

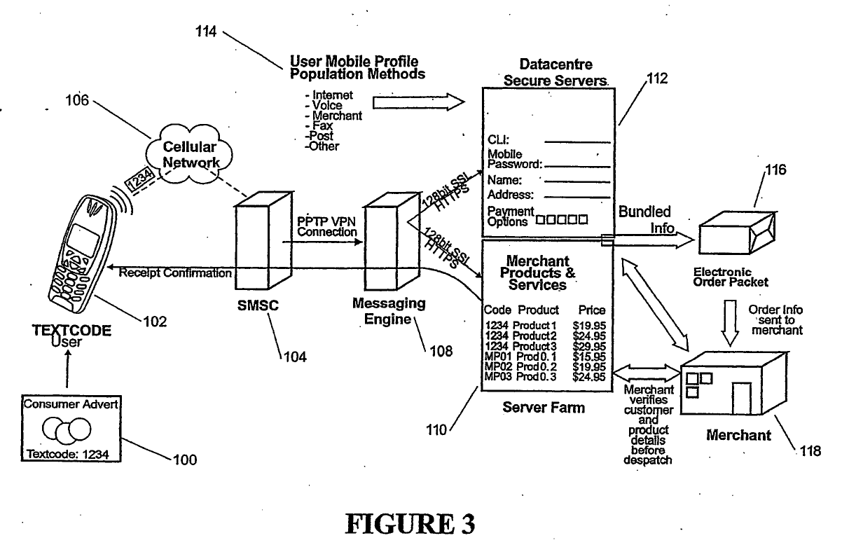

Referring to FIG. 3 the present invention is depicted according to one preferred embodiment showing a customer advert 100 displaying a text code whereby the user enters the text code into their SMS capable cellular telephone 102 which is transmitted via cellular network 106 to a SMSC 104. The messaging engine 108 receives the message from the SMSC 104 and together with user mobile profile 114 stored in the data centre secure server 112, the list of products and services held in the server farm 110 verifies whether or not the order can be dispatched. As part of the process the messaging engine parses 501 the message to identify the order code.

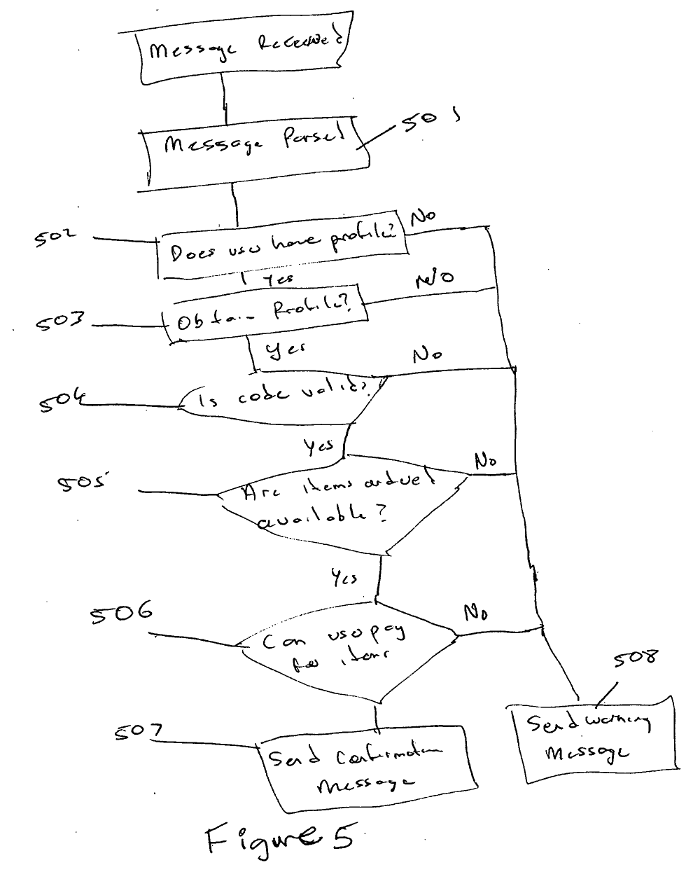

Referring to FIG. 5 confirming whether the order can be dispatched includes checking if the user has a profile 502, or if the user does not have a profile whether a profile can be sourced 503 from alternative available databases. If the user has a profile the system checks whether the order code entered by the user is a valid 504 code or not. Optionally if the code is valid the system can check if the items ordered by the code are currently available 505. The system also checks if the user can pay 506 for the ordered items. If any of the tests fail the system will send a message 508 to the user indicating that there is a problem with the order and if possible indicating the problem to the user.

The messaging engine 108 then sends a confirmation 507 to the user if the order can be processed. The user may optionally confirm in a reply message to the messaging engine 108. Once the order is confirmed an electronic order 116 is forwarded to the merchant 118 who is turn delivers the product or service.

Lottery Result Notification

The present invention comprises a further embodiment where users may register their lottery entries and be notified of success using their cellular telephone 10. The user sends ticket numbers (eg: Kachingo or Lotto numbers) as a MO message to the system server 4. The system queries the database of available barcode numbers with the contents of the message. Upon obtaining the result of the database query, the system alerts the user to their success (or failure) by return SMS message. An application on the system server 4 records the CLI (Caller Line Identification—the ability to see the phone number/mobile number of the person calling you) and ticket number information and stores them together in a database.

Multiple numbers could be sent by putting a space between the numbers in the message sent to the system by the user.

The database information is then regularly checked against the ticket providers winning numbers database or engine to find matches. This database checking is performed immediately and based on the ticket number information, at future scheduled times (i.e. for future weekly, monthly draws). Entry of ticket numbers would usually be by entering not the actual ticket number combinations but the ticket providers encrypted bar code number (normally found at the bottom of the ticket). Entry/maintenance of a user's ticket numbers could also be performed via a web site.

A mobile user is automatically sent a notification that they have won a prize based the ticket number entered in the database. This may have been for a daily, weekly of monthly draw that was either a past or future event when the ticket number was entered. If the ticket number was entered as a MO SMS message then a threaded reply using the original SMS message serial number would be sent to the original sender of the message with winning number message. Included in this message could be the ticket providers encrypted bar code number so that prizes could be collected from existing ticketing outlets. If the winning numbers were entered via the Internet then a SMS message would be sent to the user's cellular telephone as per their profile information. In order to collect prizes, users must, of course, be able to produce the actual winning ticket.

1. A method for handling an order, said order received from any “text messaging” or other wireless data transmission protocol capable wireless communication device, comprising the steps of:
receiving an order message from said wireless device;
extracting an indication of the identity of said wireless device from said order message;
obtaining information associated with said indicated identity, said information comprising information on a wireless device user associated with said wireless device identity and a nominated method of payment for said order; and
sending an order confirmation message using said identity to said wireless device.

2. A method for handling an order as claimed in claim 1 further comprising the step of verifying the ability to fulfill said order.

3. A method for handling an order as claimed in claim 2 further comprising the step of receiving information on a wireless device user, said information comprising said indicated identity of a wireless device associated with said wireless device user.

4. A method for handling an order as claimed in claim 2 further comprising the step of receiving and storing information on a wireless device user prior to receiving orders, said information comprising said indicated identity of a wireless device associated with said wireless device user.

5. A method for handling an order as claimed in claim 4 wherein the step of receiving information on a wireless device user comprises the steps of:
providing an information collecting interface for said wireless device user to provide said information; and
receiving said information provided by said wireless device user from said information collecting interface.

6. A method for handling an order as claimed in claim 5 wherein said information on said wireless device user further comprises at least one delivery address.

7. A method for handling an order as claimed in claim 6 wherein said information on said wireless device user further comprises at least one method of payment.

8. A method for handling an order as claimed in claim 7 further comprising the step of receiving a confirmation message from said wireless device indicating at least confirmation of said order.

9. A method for handling an order as claimed in claim 8 further comprising the step of storing a plurality of codes, each said code being associated with one or more items and wherein said order message comprises at least one said code and said order comprises the said one or more items associated with each said received code in said order message.

10. A method for handling an order as claimed in claim 9 wherein the said one or more items associated with a said received code in said order message depend on said indicated identity and said method further comprising the step of receiving information on items to be associated with a said received code for a said indicated identity.

11. A method for handling an order as claimed in claim 10 wherein the step of verifying the ability to fulfill said order comprises checking if said received code is one of said stored codes.

12. A method for handling an order as claimed in claim 11 wherein said order message further comprises an indication of the quantity of each said code.

13. A method for handling an order as claimed in claim 12 wherein said order message further comprises a delivery address code and said method further comprising the steps of:
receiving information on a delivery address to be associated with a said delivery address code and a said indicated identity; and
retrieving the delivery address associated with said delivery address code for said order.

14. A method for handling an order as claimed in claim 13 wherein said delivery address to be associated with a said delivery address code and a said indicated identity is received from an information collecting interface.

15. A method for handling an order as claimed in claim 12 wherein said request message comprises a delivery address.

16. A method for handling an order as claimed in claim 14 wherein said confirmation message comprises a delivery address.

17. A method for handling an order as claimed in claim 16 further comprising the step of communicating said order and said confirmation to a third party for billing purposes.

18. A method for handling an order as claimed in claim 17 further comprising the step of communicating an order for at least one ordered item to an appropriate supplier.

19. A method for handling an order as claimed in claim 18 wherein the step of communicating an order for at least one ordered item to an appropriate supplier comprises communicating a delivery address.

20. A method for handling an order as claimed in claim 19 wherein the step of communicating an order for at least one ordered item to an appropriate supplier further comprises communicating a method of payment.

21. A method for handling an order as claimed in claim 20 wherein the step of verifying the ability to fulfill said order comprises the steps of:
communicating a request for fulfillment capability information on each ordered item to at least one appropriate supplier; and
receiving fulfillment capability information from suppliers.

22. A method for handling an order as claimed in claim 14 wherein said information collecting interface is a web form.

23. A system for handling an order, said order received from any “text messaging” or other wireless data transmission protocol capable wireless communication device, comprising:
means for receiving an order message from said wireless device;
means for extracting an indication of the identity of said wireless device from said order message;
means for obtaining information associated with said indicated identity, said information comprising information on a wireless device user associated with said wireless device identity and a nominated system of payment for said order; and
means for sending an order confirmation message using said identity to said wireless device.

24. A system for handling an order as claimed in claim 23 further comprising means for verifying the ability to fulfill said order.

25. A system for handling an order as claimed in claim 24 further comprising means for receiving information on a wireless device user, said information further comprising said indicated identity of a wireless device associated with said wireless device user.

26. A system for handling an order as claimed in claim 24 further comprising means for receiving and storing information on a wireless device user prior to receiving orders, said information further comprising said indicated identity of a wireless device associated with said wireless device user.

27. A system for handling an order as claimed in claim 26 wherein the means for receiving information on a wireless device user comprises:
an information collecting interface for said wireless device user to provide said information; and
means for receiving said information provided by said wireless device user from said information collecting interface

28. A system for handling an order as claimed in claim 27 wherein said information on said wireless device user further comprises at least one delivery address.

29. A system for handling an order as claimed in claim 28 wherein said information on said wireless device user further comprises at least one method of payment.

30. A system for handling an order as claimed in claim 29 further comprising means for receiving a confirmation message from said wireless device indicating at least confirmation of said order.

31. A system for handling an order as claimed in claim 30 further comprising means for storing a plurality of codes, each said code being associated with one or more items and wherein said order message comprises at least one said code and said order comprises the said one or more items associated with each said received code in said order message.

32. A system for handling an order as claimed in claim 31 wherein the means for verifying the ability to fulfill said order comprises checking if said received code is one of said stored codes.

33. A system for handling an order as claimed in claim 32 wherein the said one or more items associated with a said received code in said order message depend on said indicated identity and said system further comprising means for receiving information on items to be associated with a said received code for a said indicated identity.

34. A system for handling an order as claimed in claim 33 wherein said order message further comprises an indication of the quantity of each said code.

35. A system for handling an order as claimed in claim 34 wherein said order message further comprises a delivery address code and said system further comprises:
means for receiving information on a delivery address to be associated with a said delivery address code and a said indicated identity; and
means for retrieving the delivery address associated with said delivery address code for said order.

36. A system for handling an order as claimed in claim 35 wherein said delivery address to be associated with a said delivery address code and a said indicated identity is received from an information collecting interface.

37. A system for handling an order as claimed in claim 34 wherein said request message comprises a delivery address.

38. A system for handling an order as claimed in claim 37 wherein said confirmation message comprises a delivery address.

39. A system for handling an order as claimed in claim 38 further comprising means for communicating said order and said confirmation to a third party for billing purposes.

40. A system for handling an order as claimed in claim 39 further comprising means for communicating an order for at least one ordered item to an appropriate supplier.

41. A system for handling an order as claimed in claim 40 wherein communicating an order for at least one ordered item to an appropriate supplier comprises communicating a delivery address.

42. A system for handling an order as claimed in claim 41 wherein communicating an order for at least one ordered item to an appropriate supplier further comprises communicating a method of payment.

43. A system for handling an order as claimed in claim 42 wherein verifying the ability to fulfill said order comprises:
means for communicating a request for fulfillment capability information on each ordered item to at least one appropriate supplier; and
means for receiving fulfillment capability information from suppliers.

44. A system for handling an order as claimed in claim 36 wherein said information collecting interface is a web form.
